(19) United States
(12) Patent Application Publication
(10) Pub. No.: US 2026/0188265 A1
(43) Pub. Date: Jul. 2, 2026

(54) DISPLAY DEVICE AND ELECTRONIC DEVICE INCLUDING THE SAME

(71) Applicant: Samsung Display Co., Ltd., Yongin-si, Gyeonggi-do (KR)

(72) Inventors: Jongwoo Jin, Yongin-si (KR); Hyunmo Lee, Yongin-si (KR); Jingu Kang, Yongin-si (KR); KIHWAN KIM, Yongin-si (KR)

(21) Appl. No.: 19/290,086

(22) Filed: Aug. 4, 2025

(30) Foreign Application Priority Data
Dec. 31, 2024 (KR) 10-2024-0202173

(51) Int. Cl. G09G 3/3291

(52) U.S. Cl. CPC G09G 3/3291; G09G 2300/0426; G09G 2320/0271; G09G 2330/021

(57) ABSTRACT

A display device includes a light-emitting element, and a first transistor connected between a driving voltage line and the light-emitting element, and including a first gate electrode and a second gate electrode positioned to face each other, the first transistor being configured to control a driving current based on a voltage applied to the first gate electrode and a voltage applied to the second gate electrode, wherein a voltage relationship between the voltage applied to the first gate electrode and the voltage applied to the second gate electrode is controlled based on a display mode.

### CROSS-REFERENCE TO RELATED APPLICATION

The present application claims priority to and the benefit of Korean Patent Application No. 10-2024-0202173, filed on Dec. 31, 2024, in the Korean Intellectual Property Office, the entire disclosure of which is incorporated herein by reference.

### BACKGROUND

### 1. Field

Aspects of the present disclosure relate to a display device and an electronic device including the same.

### 2. Description of the Related Art

A pixel emits light based on a data voltage and includes a transistor (e.g., a thin-film transistor (TFT)), which controls the driving of the pixel. A display device may display an image in a sequential emission method in which pixels emit light sequentially in units of rows or in a simultaneous emission method in which all pixels emit light simultaneously after data writing is completed sequentially.

The above information disclosed in this Background section is only for enhancement of understanding of the background of the invention and therefore it may contain information that does not form.

### SUMMARY

Aspects of some embodiments of the present disclosure are directed to a display device and an electronic device including the same. The problems to be solved by the present disclosure are not limited to those described above, and other problems and advantages of the present disclosure that are not described herein will be understood from the following description and will be more clearly understood from the embodiments. In addition, it will be appreciated that the problems to be solved by the present disclosure and the advantages may be realized by the means indicated in the patent claims and combinations thereof.

According to some embodiments of the present disclosure, there is provided a display device including: a light-emitting element; and a first transistor connected between a driving voltage line and the light-emitting element, and including a first gate electrode and a second gate electrode positioned to face each other, the first transistor being configured to control a driving current based on a voltage applied to the first gate electrode and a voltage applied to the second gate electrode, wherein a voltage relationship between the voltage applied to the first gate electrode and the voltage applied to the second gate electrode is controlled based on a display mode.

In some embodiments, the display device further includes: a first data line connected to the first gate electrode of the first transistor; a second data line connected to the second gate electrode of the first transistor; and a data driver connected to the first data line and the second data line.

In some embodiments, the data driver is configured to apply a first data voltage to the first gate electrode and a second data voltage to the second gate electrode based on the display mode.

In some embodiments, the display device further includes: a second transistor connected between the first data line and the first gate electrode and configured to turn on in response to a first gate signal; and a third transistor connected between the second data line and the second gate electrode and configured to turn on in response to a second gate signal.

In some embodiments, the display device further includes: a first data line connected to the first gate electrode of the first transistor; a second data line connected to the second gate electrode of the first transistor; a data driver connected to the first data line; and a voltage conversion circuit connected between the first data line and the second data line.

In some embodiments, the data driver is configured to apply a first data voltage to the first data line, and the voltage conversion circuit is configured to generate a second data voltage according to the first data voltage of the first data line and to apply the second data voltage to the second data line.

In some embodiments, the display device further includes: a second transistor connected between the first data line and the first gate electrode and configured to turn on in response to a first gate signal; and a third transistor connected between the second data line and the second gate electrode and configured to turn on in response to a second gate signal.

In some embodiments, the display device further includes: a data line connected to the first gate electrode of the first transistor; a data driver connected to the data line; and a voltage conversion circuit connected between the first gate electrode of the first transistor and the second gate electrode of the first transistor.

In some embodiments, the data driver is configured to apply a first data voltage to the data line, and the voltage conversion circuit is configured to generate a second data voltage based on the first data voltage applied to the first gate electrode through the data line, and to apply the second data voltage to a second data line.

In some embodiments, the display device further includes: a second transistor connected between the data line and the first gate electrode and configured to turn on in response to a first gate signal.

In some embodiments, the display mode includes a first mode for detailed gray scale expression in a low gray scale region and a second mode for output efficiency in a high gray scale region.

In some embodiments, in the first mode, control is performed so that, in response to the voltage applied to the first gate electrode increasing, the voltage applied to the second gate electrode decreases.

In some embodiments, in the second mode, control is performed so that, in response to the voltage applied to the first gate electrode increasing, the voltage applied to the second gate electrode increases.

According to some embodiments of the present disclosure, there is provided an electronic device including: a memory; a processor configured to execute an application stored in the memory; and a display module configured to process a signal transmitted from the processor and to output image information, the display module including: a light-emitting element; and a first transistor connected between a driving voltage line and the light-emitting element, and including a first gate electrode and a second gate electrode positioned to face each other, the first transistor being configured to control a driving current based on a voltage applied to the first gate electrode and a voltage applied to the second gate electrode, wherein a voltage relationship between the voltage applied to the first gate electrode and the voltage applied to the second gate electrode is controlled based on a display mode.

In some embodiments, the electronic device further includes: a first data line connected to the first gate electrode of the first transistor; a second data line connected to the second gate electrode of the first transistor; and a data driver connected to the first data line and the second data line.

In some embodiments, the data driver is configured to apply a first data voltage to the first gate electrode and a second data voltage to the second gate electrode based on the display mode.

In some embodiments, the electronic device further includes: a first data line connected to the first gate electrode of the first transistor; a second data line connected to the second gate electrode of the first transistor; a data driver connected to the first data line; and a voltage conversion circuit connected between the first data line and the second data line.

In some embodiments, the data driver is configured to apply a first data voltage to the first data line, and the voltage conversion circuit is configured to generate a second data voltage according to the first data voltage of the first data line and to apply the second data voltage to the second data line.

In some embodiments, the electronic device further includes: a data line connected to the first gate electrode of the first transistor; a data driver connected to the data line; and a voltage conversion circuit connected between the first gate electrode of the first transistor and the second gate electrode of the first transistor.

In some embodiments, the data driver is configured to apply a first data voltage to the data line, and the voltage conversion circuit is configured to generate a second data voltage, based on the first data voltage applied to the first gate electrode through the data line, and to apply the second data voltage to a second data line.

Other aspects, features, and advantages of the present disclosure will become better understood through the accompanying drawings, the appended claims, and the detailed description.

### BRIEF DESCRIPTION OF THE DRAWINGS

The above and other aspects, features, and advantages of certain embodiments of the present disclosure will be more apparent from the following description taken in conjunction with the accompanying drawings in which:

FIG. 1 is a perspective view illustrating a display device according to some embodiments of the present disclosure;

FIG. 2 is a cross-sectional view illustrating a display device according to some embodiments of the present disclosure;

FIG. 3 is a plan view illustrating a display of a display device according to some embodiments of the present disclosure;

FIG. 4 is a block diagram illustrating a display panel and a driver according to some embodiments of the present disclosure;

FIG. 5 is a graph showing characteristic curves of a transistor according to some embodiments of the present disclosure;

FIG. 6 is a diagram illustrating a display device according to some embodiments of the present disclosure;

FIG. 7 is a diagram illustrating a display device according to some other embodiments of the present disclosure;

FIG. 8 is a diagram illustrating a display device according to some other embodiments of the present disclosure;

FIG. 9 is a cross-sectional view of a display device including a first transistor, according to some embodiments of the present disclosure;

FIG. 10 is a block diagram of an electronic device according to some embodiments of the present disclosure; and

FIG. 11 is a schematic diagram of electronic devices according to some embodiments of the present disclosure.

### DETAILED DESCRIPTION

As the present description allows for various changes and numerous embodiments, certain embodiments will be illustrated in the drawings and described in detail in the written description. Effects and features of the present disclosure, and methods of achieving them will be clarified with reference to embodiments described below in detail with reference to the drawings. However, the present disclosure is not limited to the following embodiments and may be embodied in various forms.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include,” “including,” “comprises,” “comprising,” “has,” “have,” and “having,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items. For example, the expression “A and/or B” denotes A, B, or A and B. Expressions such as “one or more of” and “at least one of,” when preceding a list of elements, modify the entire list of elements and do not modify the individual elements of the list. For example, the expression “one or more of A, B, and C,” “at least one of A, B, or C,” “at least one of A, B, and C,” and “at least one selected from the group consisting of A, B, and C” indicates only A, only B, only C, both A and B, both A and C, both B and C, or all of A, B, and C.

Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to”, “coupled to”, or “adjacent” another element or layer, it can be directly on, connected to, coupled to, or adjacent the other element or layer, or one or more intervening elements or layers may be present. When an element or layer is referred to as being “directly on,” “directly connected to”, “directly coupled to”, “in contact with”, “in direct contact with”, or “immediately adjacent” another element or layer, there are no intervening elements or layers present.

As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Also, sizes of elements in the drawings may be exaggerated or reduced for convenience of explanation. For example, because sizes and/or thicknesses of elements in the drawings are arbitrarily illustrated for convenience of explanation, the present disclosure is not limited thereto.

Hereinafter, embodiments will be described in detail with reference to the accompanying drawings. When describing embodiments with reference to the accompanying drawings, the same or corresponding elements are denoted by the same reference numerals, and redundant descriptions thereof are omitted.

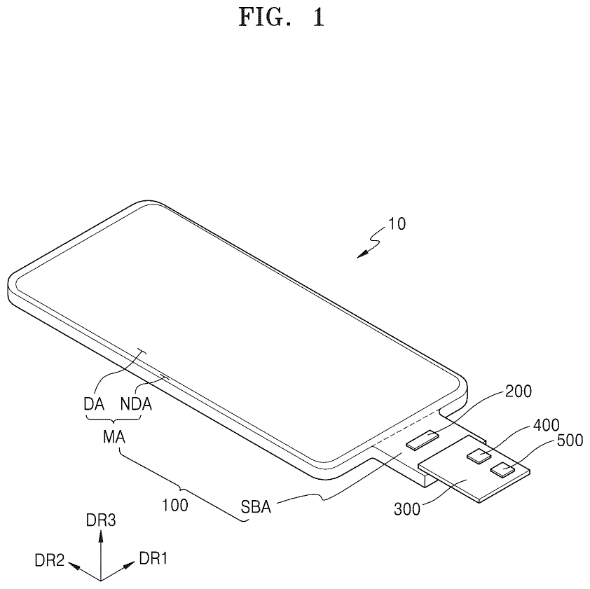

FIG. 1 is a perspective view illustrating a display device 10 according to some embodiments of the present disclosure.

Referring to FIG. 1, the display device 10 may be applied to a portable electronic device, such as a mobile phone, a smartphone, a tablet personal computer (PC), a mobile communication terminal, an electronic organizer, an e-book, a portable multimedia player (PMP), a navigation system, or an ultra-mobile PC (UMPC). For example, the display device 10 may be applied as a display of a television, a laptop, a monitor, a billboard, or an Internet of things (IOT) device. As another example, the display device 10 may be applied to a wearable device, such as a smart watch, a watch phone, a glasses-type display, or a head mounted display (HMD).

The display device 10 may have a planar shape that is similar to a rectangular shape. For example, the display device 10 may have a planar shape that is similar to a rectangular shape having a short side in a first direction DR1 and a long side in a second direction DR2. Corners at which the short side in the first direction DR1 meets the long side in the second direction DR2 may be round to have a certain curvature, or may be at a right angle. The planar shape of the display device 10 is not limited to the rectangular shape and may be similar to other polygonal, circular, elliptical shapes, or have any other suitable shape.

The display device 10 may include a display panel 100, a driver 200, a circuit board 300, a touch driver 400, and a power supply 500.

The display panel 100 may include a main area MA and a sub-area SBA.

The main area MA may include a display area DA in which pixels configured to display images are disposed and a non-display area NDA disposed around the display area DA. The display area DA may allow light to be emitted from a plurality of emission areas or a plurality of opening areas. For example, the display panel 100 may include a pixel circuit including switching elements, a pixel defining film defining an emission area or an opening area, and a light-emitting element.

For example, the light-emitting element may include at least one of an organic light-emitting diode (LED) including an organic light-emitting layer, a quantum dot LED including a quantum dot light-emitting layer, an inorganic LED including an inorganic semiconductor, or a micro LED, but the present disclosure is not limited thereto.

The non-display area NDA may be an area outside the display area DA. The non-display area NDA may be defined as an edge area of the main area MA of the display panel 100. The non-display area NDA may include a gate driver configured to supply gate signals to gate lines, and fan-out lines configured to connect the driver 200 to the display area DA.

The sub-area SBA may extend from a side of the main area MA. The sub-area SBA may include a flexible material, which is bendable, foldable, or rollable. For example, in cases where the sub-area SBA is bent, the sub-area SBA may overlap the main area MA in a thickness direction (e.g., a third direction DR3). The sub-area SBA may include the driver 200 and a pad portion connected to the circuit board 300. As another example, the sub-area SBA may be omitted, and the driver 200 and the pad portion may be disposed in the non-display area NDA.

The driver 200 may be configured to output signals and voltages for driving the display panel 100 or the pixels. The driver 200 may be configured to supply data voltages to data lines. The driver 200 may be configured to provide power supply voltages to power lines and supply a gate control signal to the gate driver. The driver 200 may be formed as an integrated circuit (IC) and may be mounted on the display panel 100 through chip on glass (COG), chip on plastic (COP), or ultrasonic bonding. For example, the driver 200 may be disposed in the sub-area SBA and may overlap the main area MA in the thickness direction (e.g., the third direction DR3) by the bending of the sub-area SBA. As another example, the driver 200 may be mounted on the circuit board 300.

The circuit board 300 may be attached to the pad portion of the display panel 100 by using an anisotropic conductive film (ACF). Lead lines of the circuit board 300 may be electrically connected to the pad portion of the display panel 100. The circuit board 300 may be a flexible printed circuit board, a printed circuit board, or a flexible film, such as a chip on film.

The touch driver 400 may be mounted on the circuit board 300. The touch driver 400 may be electrically connected to a touch sensor of the display panel 100. The touch driver 400 may be configured to supply a touch driving signal to a plurality of touch electrodes of the touch sensor and sense an amount of change in electrostatic capacitance between the plurality of touch electrodes. For example, the touch driving signal may be a pulsed signal having a predefined frequency. The touch driver 400 may be configured to determine the presence or absence of input and calculate input coordinates, based on the amount of change in electrostatic capacitance between the plurality of touch electrodes. The touch driver 400 may be formed as an IC.

The power supply 500 may be disposed on the circuit board 300 and may be configured to supply the power supply voltages to the driver 200 and the display panel 100. The power supply 500 may be configured to generate a first driving voltage and supply the first driving voltage to a first driving voltage line. The power supply 500 may be configured to generate an initialization voltage (e.g., a first initialization voltage and a second initialization voltage) and supply the initialization voltage to an initialization voltage line (e.g., a first initialization voltage line and a second initialization voltage line). The power supply 500 may be configured to generate a common voltage and supply the common voltage to a common electrode, which is common to the light-emitting elements of the plurality of pixels. For example, the first driving voltage may be a high-potential voltage for driving the light-emitting element, and the common voltage may be a low-potential voltage for driving the light-emitting element.

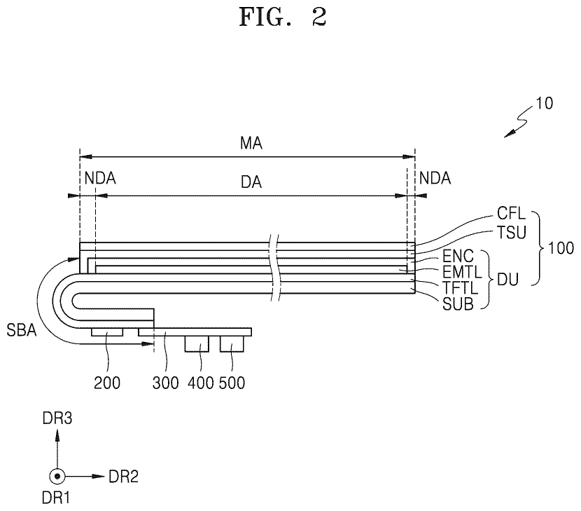

FIG. 2 is a cross-sectional view illustrating a display device 10 according to some embodiments of the present disclosure.

Referring to FIG. 2, a display panel 100 may include a display DU, a touch sensor TSU, and a color filter layer CFL. The display DU may include a substrate SUB, a thin-film transistor (TFT) layer TFTL, a light-emitting element layer EMTL, and an encapsulation layer ENC.

The substrate SUB may be a base substrate or a base member. The substrate SUB may be a flexible substrate SUB, which is bendable, foldable, or rollable. For example, the substrate SUB may include polymer resin, such as polyimide (PI), but the present disclosure is not limited thereto. As another example, the substrate SUB may include a glass material or a metal material.

The TFT layer TFTL may be disposed on the substrate SUB. The TFT layer TFTL may include a plurality of TFTs constituting a pixel circuit of pixels. The TFT layer TFTL may further include gate lines, data lines, power lines, gate control lines, fan-out lines configured to connect a driver 200 to the data lines, and lead lines configured to connect the driver 200 to a pad portion. Each of the TFTs may include a semiconductor region, a source electrode, a drain electrode, and a gate electrode. For example, in cases where a gate driver is formed on a side of a non-display area NDA of the display panel 100, the gate driver may include TFTs.

The TFT layer TFTL may be disposed in a display area DA, the non-display area NDA, and a sub-area SBA. The TFTs, the gate lines, the data lines, and the power lines of each of the pixels of the TFT layer TFTL may be disposed in the display area DA. The gate control lines and the fan-out lines of the TFT layer TFTL may be disposed in the non-display area NDA. The lead lines of the TFT layer TFTL may be disposed in the sub-area SBA.

The light-emitting element layer EMTL may be disposed on the TFT layer TFTL. The light-emitting element layer EMTL may include a plurality of light-emitting elements in which a pixel electrode, an emission layer, and a common electrode are sequentially stacked (in this stated order) to emit light, and a pixel defining film, which defines pixels. The plurality of light-emitting elements of the light-emitting element layer EMTL may be disposed in the display area DA.

For example, the emission layer may be an organic light-emitting layer including an organic material. The emission layer may include a hole transporting layer, an organic light-emitting layer, and an electron transporting layer. When the pixel electrode receives a voltage through the TFT of the TFT layer TFTL and the common electrode receives a cathode voltage, holes and electrons may move to the organic light-emitting layer through the hole transporting layer and the electron transporting layer, respectively, and recombine with each other in the organic light-emitting layer to emit light. For example, the pixel electrode may be an anode electrode and the common electrode may be a cathode electrode, but the present disclosure is not limited thereto.

As another example, each of the light-emitting elements may include a quantum dot LED including a quantum dot light-emitting layer, an inorganic LED including an inorganic semiconductor, or a micro LED.

The encapsulation layer ENC may cover the upper surface and the side surface of the light-emitting element layer EMTL and protect the light-emitting element layer EMTL. The encapsulation layer ENC may include at least one inorganic film and at least one organic film, which encapsulate the light-emitting element layer EMTL.

The touch sensor TSU may be disposed on the encapsulation layer ENC. The touch sensor TSU may include a plurality of touch electrodes configured to sense a user's touch in a capacitance method and touch lines configured to connect the plurality of touch electrodes to a touch driver 400. For example, the touch sensor TSU may sense a user's touch by using a mutual capacitance method or a self-capacitance method.

As another example, the touch sensor TSU may be disposed on a separate substrate SUB, which is disposed on the display DU. In this case, the substrate SUB, which supports the touch sensor TSU, may be a base member that encapsulates the display DU.

The plurality of touch electrodes of the touch sensor TSU may be disposed in a touch sensor area that overlaps the display area DA. The touch lines of the touch sensor TSU may be disposed in a touch peripheral area that overlaps the non-display area NDA.

The color filter layer CFL may be disposed on the touch sensor TSU. The color filter layer CFL may include a plurality of color filters respectively corresponding to a plurality of emission areas. Each of the color filters may be configured to selectively transmit light of a specific wavelength and block or absorb light of the other wavelengths. The color filter layer CFL may reduce reflected light caused by external light by absorbing a portion of light incident from the outside of the display device 10. Therefore, the color filter layer CFL may prevent color distortion caused by external light reflection.

Because the color filter layer CFL is disposed directly on the touch sensor TSU, the display device 10 may not require a separate substrate SUB for the color filter layer CFL. Accordingly, the thickness of the display device 10 may be relatively reduced.

The sub-area SBA of the display panel 100 may extend from a side of the main area MA. The sub-area SBA may include a flexible material, which is bendable, foldable, or rollable. For example, in cases where the sub-area SBA is bent, the sub-area SBA may overlap the main area MA in the thickness direction (e.g., the third direction DR3). The sub-area SBA may include the driver 200 and the pad portion electrically connected to a circuit board 300.

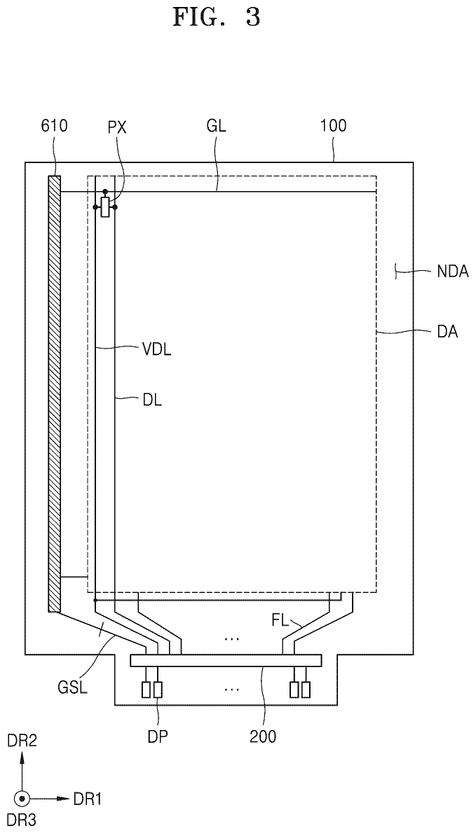

FIG. 3 is a plan view illustrating a display of a display device according to some embodiments of the present disclosure.

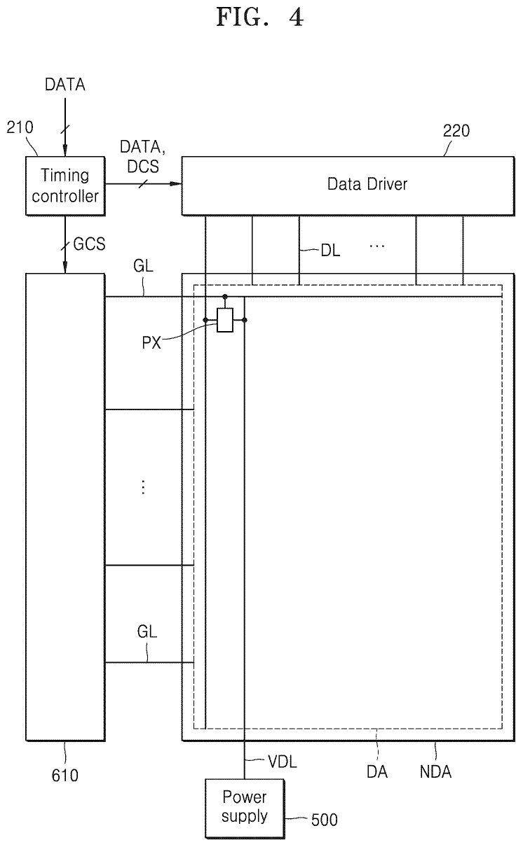

FIG. 4 is a block diagram illustrating a display panel 100 and a driver 200 according to some embodiments of the present disclosure.

Referring to FIGS. 3 and 4, the display panel 100 may include a display area DA and a non-display area NDA.

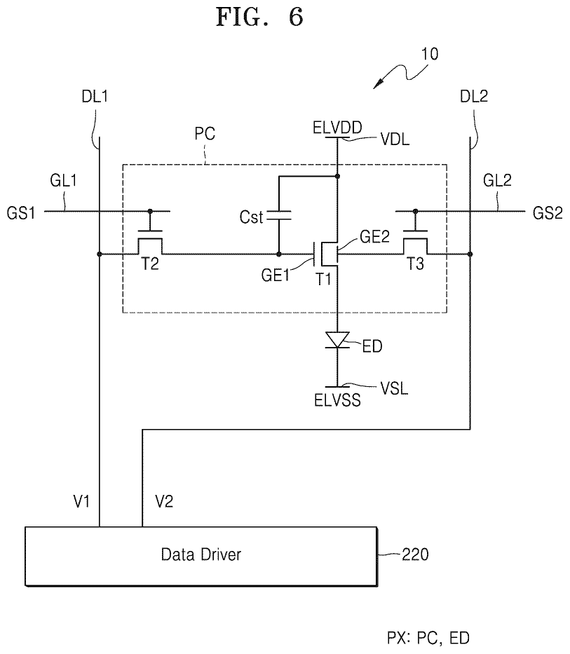

The display area DA may include a plurality of pixels PX and include a plurality of driving voltage lines VDL, and a plurality of gate lines GL and a plurality of data lines DL of a plurality of common voltage lines (e.g., VSL in FIG. 6), which are respectively connected to the plurality of pixels PX.

The plurality of pixels PX may be respectively connected to the gate lines GL, the data lines DL, the driving voltage lines VDL, and the common voltage lines (e.g., a common voltage line VSL in FIG. 6). Each of the plurality of pixels PX may include at least one transistor, a light-emitting element, and a capacitor.

The gate lines GL may each extend in the first direction DR1 and may be spaced apart from each other in the second direction DR2 crossing the first direction DR1. The gate lines GL may be disposed along the second direction DR2. The gate lines GL may be configured to sequentially supply gate signals to the plurality of pixels PX.

The data lines DL may each extend in the second direction DR2 and may be spaced apart from each other in the first direction DR1. The data lines DL may be disposed along the first direction DR1. The data lines DL may be configured to supply data voltages to the plurality of pixels PX. The data voltage may determine the luminance of each of the plurality of pixels PX. According to some embodiments, a pixel may be connected to two different data lines. For example, a pixel may be connected to a first data line and a second data line.

The driving voltage lines VDL may each extend in the second direction DR2 and may be spaced apart from each other in the first direction DR1. The driving voltage lines VDL may be disposed along the first direction DR1. The driving voltage lines VDL may be configured to supply driving voltages to the plurality of pixels PX. The driving voltage may be a high-potential voltage for driving the light-emitting elements of the pixels PX.

The non-display area NDA may surround the display area DA. The non-display area NDA may include a gate driver 610, fan-out lines FL, and a gate control line GSL.

The fan-out lines FL may extend from the driver 200 to the display area DA. The fan-out lines FL may be configured to supply, to the plurality of data lines DL, data voltages received from the driver 200.

The gate control line GSL may extend from the driver 200 to the gate driver 610. The gate control line GSL may be configured to supply, to the gate driver 610, a gate control signal GCS received from the driver 200.

The sub-area SBA may extend from a side of the non-display area NDA. The sub-area SBA may include the driver 200 and a pad portion DP. The pad portion DP may be disposed closer to an edge of the sub-area SBA than the driver 200. The pad portion DP may be electrically connected to a circuit board through an ACF.

The driver 200 may include a timing controller 210 and a data driver 220.

The timing controller 210 may be configured to receive digital video data DATA and timing signals from the circuit board. The timing controller 210 may be configured to control an operation timing of the data driver 220 by generating a data control signal DCS, based on the timing signals, may control an operation timing of the gate driver 610 by generating the gate control signal GCS, and may control an operation timing of an emission control driver by generating an emission control signal. The timing controller 210 may be configured to supply the gate control signal GCS to the gate driver 610 through the gate control line GSL. The timing controller 210 may be configured to supply the digital video data DATA and the data control signal DCS to the data driver 220.

The data driver 220 may be configured to convert the digital video data DATA into analog data voltages and supply the analog data voltages to the data lines DL through the fan-out lines FL. The gate signals of the gate driver 610 may be configured to select pixels PX to which the data voltages are supplied, and the selected pixels PX may be configured to receive the data voltages through the data lines DL.

A power supply 500 may be disposed on the circuit board and may be configured to supply the power supply voltages to the driver 200 and the display panel 100. The power supply 500 may be configured to generate a first driving voltage and supply the first driving voltage to the driving voltage line VDL, to generate an initialization voltage and supply the initialization voltage to an initialization voltage line, and to generate a common voltage and supply the common voltage to a common electrode, which is common to the light-emitting elements of the plurality of pixels. The common voltage may be applied to the common electrode through the common voltage line (e.g., a common voltage line VSL in FIG. 6).

The gate driver 610 may be disposed outside a side of the display area DA or on a side of the non-display area NDA, and the emission control driver may be disposed outside another side of the display area DA or on another side of the non-display area NDA, but the present disclosure is not limited thereto. As another example, the gate driver 610 and the emission control driver may be disposed on either a side or another side of the non-display area NDA.

The gate driver 610 may include a plurality of transistors configured to generate the gate signals, based on the gate control signal GCS. The transistors of the gate driver 610 may be formed in the same layer as the transistors of each of the pixels PX. The gate driver 610 may be configured to supply the gate signals to the gate lines GL.

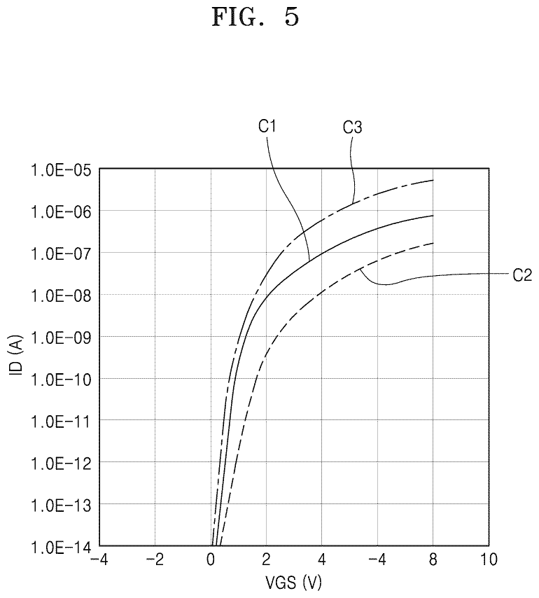

FIG. 5 is a graph showing characteristic curves of a transistor according to some embodiments of the present disclosure.

FIG. 5 are characteristic curves showing a drain current ID of a first transistor (e.g., a first transistor T1 of FIG. 6) provided in the display device 10 with respect to a gate-source voltage VGS of the first transistor T1.

In the display device 10 according to some embodiments, a pixel driving range may be adjusted according to a gray scale region.

Referring to a first characteristic curve C1 of FIG. 5, as the gate-source voltage VGS increases, the drain current ID increases, but the slope of the curve decreases. Accordingly, the increase range of the drain current ID may decrease. Accordingly, in a low gray scale region, that is, a region where the gate-source voltage VGS is low, the drain current ID may change rapidly even with a small change in the gate-source voltage VGS, which may make it difficult to make detailed gray scale expression.

Referring to a second characteristic curve C2 of FIG. 5, the second characteristic curve C2 may have a gentler slope than the first characteristic curve C1. For example, in the second characteristic curve C2, the change in the drain current ID with respect to the change in the gate-source voltage VGS in the low gray scale region, that is, the region where the gate-source voltage VGS is low, may be gentler than in the first characteristic curve C1. Accordingly, in cases where the operation of the first transistor T1 follows the second characteristic curve C2, detailed gray scale expression may be facilitated.

Referring again to the first characteristic curve C1 of FIG. 5, the change in the drain current ID with respect to the change in the gate-source voltage VGS may be small in a high gray scale region, that is, a region where the gate-source voltage VGS is high. Accordingly, a high voltage and high power consumption may be required for gray scale expression corresponding to the high gray scale region.

Referring to a third characteristic curve C3 of FIG. 5, the third characteristic curve C3 may have a steeper slope than the first characteristic curve C1. For example, in the third characteristic curve C3, the change in the drain current ID with respect to the change in the gate-source voltage VGS in the high gray scale region, that is, the region where the gate-source voltage VGS is high, may be steeper than in the first characteristic curve C1. Accordingly, in cases where the operation of the first transistor T1 follows the third characteristic curve C3, power efficiency may be improved.

In summary, for gray scale expression corresponding to the low gray scale region, it may be desirable for the first transistor T1 to operate according to the second characteristic curve C2, and for gray scale expression corresponding to the high gray scale region, it may be desirable for the first transistor T1 to operate according to the third characteristic curve C3. Accordingly, the display device 10 of the present disclosure may change characteristics of the first transistor T1, based on a display mode set for the display device 10. Characteristics of the first transistor T1 may be changed by the driver 200 or the data driver 220.

In the present disclosure, the display mode may be one of a first operation mode, which is a reference mode as a general operation mode, a second operation mode, which is a mode for detailed gray scale expression in a low gray scale region, and a third operation mode, which is a mode for efficiently generating an output in a high gray scale region. The first operation mode may be a mode in which the first transistor T1 is controlled to operate according to the first characteristic curve C1 of FIG. 5, the second operation mode may be a mode in which the first transistor T1 is controlled to operate according to the second characteristic curve C2 of FIG. 5, and the third operation mode may be a mode in which the first transistor T1 is controlled to operate according to the third characteristic curve C3 of FIG. 5.

The first transistor T1 of the pixel PX included in the display device 10 of the present disclosure may include two gate electrodes, that is, a first gate electrode (e.g., a first gate electrode GE1 of FIG. 6) and a second gate electrode (e.g., a second gate electrode GE2 of FIG. 6). A first gate voltage (e.g., a first gate voltage V1 of FIG. 6) may be applied to the first gate electrode GE1, and a second gate voltage (e.g., a second gate voltage V2 of FIG. 6) may be applied to the second gate electrode GE2.

The display device 10 of the present disclosure may be configured to supply a data voltage, based on the display mode. For example, the display device 10 of the present disclosure may control a voltage applied to the first gate electrode GE1 of the first transistor T1 and a voltage applied to the second gate electrode GE2 of the first transistor T1, based on the display mode. Operation characteristics of the first transistor T1 including the first gate electrode GE1 and the second gate electrode GE2 may vary depending on a relationship between the voltages respectively applied to the first gate electrode GE1 and the second gate electrode GE2.

In the second operation mode, when the voltage applied to the first gate electrode GE1 increases, the display device 10 of the present disclosure may control the voltage applied to the first transistor T1 in a direction in which the voltage applied to the second gate electrode GE2 decreases. For example, the display device 10 may control the first transistor T1 to operate according to the second operation mode, that is, according to the second characteristic curve C2, by increasing an absolute value of the voltage applied to the second gate electrode GE2, which is a negative voltage.

In the third operation mode, when the voltage applied to the first gate electrode GE1 increases, the display device 10 of the present disclosure may control the voltage applied to the first transistor T1 in a direction in which the voltage applied to the second gate electrode GE2 increases. For example, the display device 10 may control the first transistor T1 to operate according to the third operation mode, that is, according to the third characteristic curve C3, by increasing an absolute value of the voltage applied to the second gate electrode GE2, which is a positive voltage.

Hereinafter, embodiments that implement the display device 10 of the present disclosure are described.

FIG. 6 is a diagram illustrating a display device according to some embodiments of the present disclosure.

Some embodiments in which a voltage applied to a first gate electrode GE1 and a voltage applied to a second gate electrode GE2 are controlled based on a display mode by a data driver 220 is described with reference to FIG. 6.

Referring to FIG. 6, a pixel PX may be connected to a first gate line GL1, a second gate line GL2, a first data line DL1, and a second data line DL2.

The pixel PX may include a pixel circuit PC and a light-emitting element ED.

The pixel circuit PC may include a first transistor T1, a second transistor T2, a third transistor T3, and a capacitor Cst.

The first transistor T1 may include the first gate electrode GE1, the second gate electrode GE2, a source electrode, and a drain electrode. The first transistor T1 may be configured to control a source-drain current (hereinafter, a driving current) according to a first data voltage V1 applied to the first gate electrode GE1 and a second data voltage V2 applied to the second gate electrode GE2. The first gate electrode GE1 of the first transistor T1 may be electrically connected to a source electrode of the second transistor T2, the second gate electrode GE2 of the first transistor T1 may be electrically connected to a source electrode of the third transistor T3, the drain electrode of the first transistor T1 may be electrically connected to a driving voltage line VDL, and the source electrode of the first transistor T1 may be connected to a first electrode (e.g., an anode electrode or a pixel electrode) of the light-emitting element ED. The driving voltage line VDL may be configured to transmit a driving voltage ELVDD.

The light-emitting element ED may be configured to receive the driving current and emit light. Luminance or an amount of light emitted from the light-emitting element ED may be proportional to an amount of the driving current. The light-emitting element ED may include the first electrode, a second electrode (e.g., a cathode electrode or a common electrode), and an organic light-emitting layer. The organic light-emitting layer may be disposed between the first electrode and the second electrode. As another example, the light-emitting element ED may be an inorganic light-emitting element ED, which may include a first electrode, a second electrode, and an inorganic semiconductor. The inorganic semiconductor may be disposed between the first electrode and the second electrode. As another example, the light-emitting element ED may be a quantum dot light-emitting element ED, which may include a first electrode, a second electrode, and a quantum dot light-emitting layer. The quantum dot light-emitting layer may be disposed between the first electrode and the second electrode. As another example, the light-emitting element ED may be a micro LED. The first electrode of the light-emitting element ED may be electrically connected to the source electrode of the first transistor T1. The second electrode of the light-emitting element ED may be connected to a common voltage line VSL. The second electrode of the light-emitting element ED may be configured to receive a common voltage ELVSS (e.g., a low potential voltage) from the common voltage line VSL.

The second transistor T2 may be configured to be turned on in response to a first gate signal GS1 of the first gate line GL1 and to electrically connect the first data line DL1 to the first gate electrode GE1 of the first transistor T1. Because the second transistor T2 is turned on in response to the first gate signal GS1, the first data voltage V1 of the first data line DL1 may be supplied to the first gate electrode GE1 of the first transistor T1. A gate electrode of the second transistor T2 may be electrically connected to the first gate line GL1, a drain electrode of the second transistor T2 may be electrically connected to the first data line DL1, and a source electrode of the second transistor T2 may be electrically connected to the first gate electrode GE1 of the first transistor T1.

The third transistor T3 may be configured to be turned on in response to a second gate signal GS2 of the second gate line GL2 and to electrically connect the second data line DL2 to the second gate electrode GE2 of the first transistor T1. When the third transistor T3 is turned on in response to the second gate signal GS2, the second data voltage V2 of the second data line DL2 may be supplied to the second gate electrode GE2 of the first transistor T1. A gate electrode of the third transistor T3 may be electrically connected to the second gate line GL2, a drain electrode of the third transistor T3 may be electrically connected to the second data line DL2, and a source electrode of the third transistor T3 may be electrically connected to the second gate electrode GE2 of the first transistor T1.

The capacitor Cst may be electrically connected between the gate electrode of the first transistor T1 and the driving voltage line VDL. A first electrode of the capacitor Cst may be electrically connected to the first gate electrode GE1 of the first transistor T1, and a second electrode of the capacitor Cst may be electrically connected to the driving voltage line VDL. The capacitor Cst may store, for example, the first data voltage V1 supplied from the first data line DL1 through the first transistor T1.

The first transistor T1, the second transistor T2, and the third transistor T3 may each include an oxide-based active layer. The oxide-based active layer may include, for example, indium-gallium-zinc-oxide (IGZO) or indium-gallium-zinc-tin oxide (IGZTO). The transistor including the oxide-based active layer may have a coplanar structure in which a gate electrode is disposed on an upper side. The transistor including the oxide-based active layer may correspond to an n-type transistor and may be configured to output, to the source electrode, current flowing into the drain electrode in response to a gate high voltage applied to the gate electrode.

As described above, the data driver 220 may be configured to supply the data voltage for driving the pixel circuit PC, and the first transistor T1 may include the first gate electrode GE1 and the second gate electrode GE2.

As illustrated in FIG. 6, the data driver 220 according to some embodiments may be configured to generate and supply both the first data voltage V1 and the second data voltage V2. The data driver 220 may be connected to both the first data line DL1 and the second data line DL2 and may be configured to supply the first data voltage V1 through the first data line DL1 and the second data voltage V2 through the second data line DL2.

In some embodiments, the data driver 220 may be configured to concurrently (e.g., simultaneously) supply the first data voltage V1 and the second data voltage V2. In the present embodiment, the second transistor T2 and the third transistor T3 may be configured to be concurrently (e.g., simultaneously) turned on. For example, a turn-on timing of the second transistor T2 may be the same or substantially the same as a turn-on timing of the third transistor T3. The first data voltage V1 from the data driver 220 may be applied to the first gate electrode GE1 at a turn-on timing of the second transistor T2, and the second data voltage V2 from the data driver 220 may be applied to the second gate electrode GE2 at a turn-on timing of the third transistor T3. A turn-off timing of the second transistor T2 may also be the same or substantially the same as a turn-off timing of the third transistor T3. To this end, in some embodiments, the first gate signal GS1 applied to the first gate line GL1 connected to the gate electrode of the second transistor T2 may be the same as the second gate signal GS2 applied to the second gate line GL2 connected to the gate electrode of the third transistor T3. For example, during the emission period of the pixel, the first gate signal GS1 applied to the first gate line GL1 and the second gate signal GS2 applied to the second gate line GL2 may be output at the same or substantially the same timing and maintained for the same or substantially the same period of time.

As described above, both the first data voltage V1 and the second data voltage V2 may be generated by the data driver 220, and the magnitude of the turn-on of the first transistor T1 may be controlled by the first data voltage V1 and the second data voltage V2. For example, in cases where the first transistor T1 is an n-type transistor, the first transistor T1 may be turned on so that more current flows through the first transistor T1 as the first data voltage V1 increases, and the first transistor T1 may be turned on so that less current flows through the first transistor T1 as the second data voltage V2 decreases. For example, in cases where the second data voltage V2 is a negative voltage, less current may flow through the first transistor T1 as an absolute value of the negative voltage increases. The second data voltage V2 may have a magnitude that is different from a magnitude of the first data voltage V1. For example, in cases where the first transistor T1 is a p-type transistor, the first transistor T1 may be turned on so that more current flows through the first transistor T1 as the first data voltage V1 decreases, and the first transistor T1 may be turned on so that less current flows through the first transistor T1 as the second data voltage V2 increases. For example, in cases where the second data voltage V2 is a positive voltage, less current may flow through the first transistor T1 as an absolute value of the positive voltage increases.

In cases where the magnitude of the second data voltage V2 applied to the second gate electrode GE2 of the first transistor T1 varies depending on the magnitude of the first data voltage V1 applied to the first gate electrode GE1 of the first transistor T1, the characteristic curve of the first transistor T1 (e.g., the characteristic curve showing the amount of change in the drain current according to the gate-source voltage of the first transistor T1) may vary. Accordingly, by appropriately changing the magnitude of the second data voltage V2 according to the first data voltage V1, the characteristic curve of the first transistor T1 may be changed to have a gentle slope or a steep slope. The expression “the characteristic curve of the first transistor T1 has a gentle slope” may mean that the display device 10 is controlled to operate in the second operation mode, and the expression “the characteristic curve of the first transistor T1 has a steep slope” may mean that the display device 10 is controlled to operate in the third operation mode.

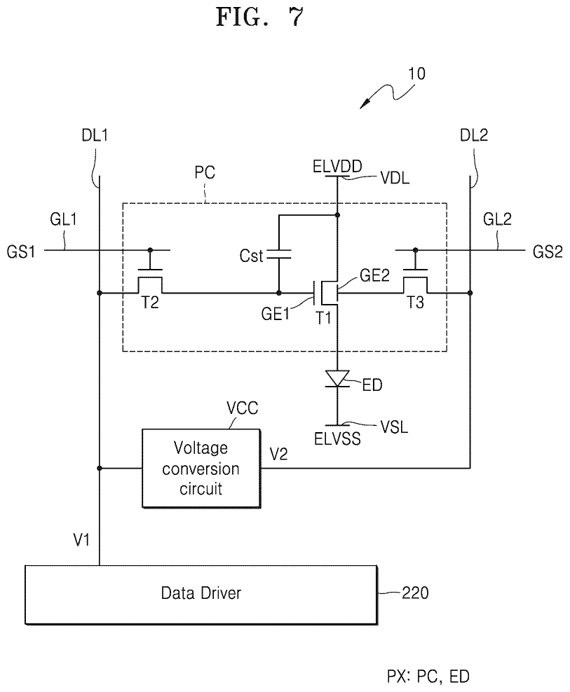

FIG. 7 is a diagram illustrating a display device 10 according to some other embodiments of the present disclosure.

The display device 10 of FIG. 7 may further include a voltage conversion circuit VCC. Some embodiments in which a voltage applied to a first gate electrode GE1 and a voltage applied to a second gate electrode GE2 are controlled by a data driver 220 and the voltage conversion circuit VCC is described with reference to FIG. 7. Hereinafter, mainly the differences between the embodiments illustrated in FIG. 6 and the embodiments illustrated in FIG. 7 are described.

In some embodiments, the data driver 220 may be configured to generate a data voltage, and the generated data voltage may be a first data voltage V1 or a second data voltage V2 of a first transistor T1. In FIG. 7, the data voltage generated by the data driver 220 is described as the first data voltage V1. The first data voltage V1 may be supplied to a first data line DL1 and the voltage conversion circuit VCC.

In some embodiments, the voltage conversion circuit VCC may be connected between the first data line DL1 and a second data line DL2. The voltage conversion circuit VCC may be configured to receive the first data voltage V1 through the first data line DL1 and convert the first data voltage V1 into a second data voltage V2. The second data voltage V2 from the voltage conversion circuit VCC may be supplied to the second data line DL2.

In some embodiments, the voltage conversion circuit VCC may be disposed on a display panel. For example, the voltage conversion circuit VCC may be disposed outside a pixel circuit PC.

Because the first data voltage V1 and the second data voltage V2 of FIG. 7 are respectively the same as the first data voltage V1 and the second data voltage V2 of FIG. 6 described above, a detailed description thereof may not be repeated hereinafter.

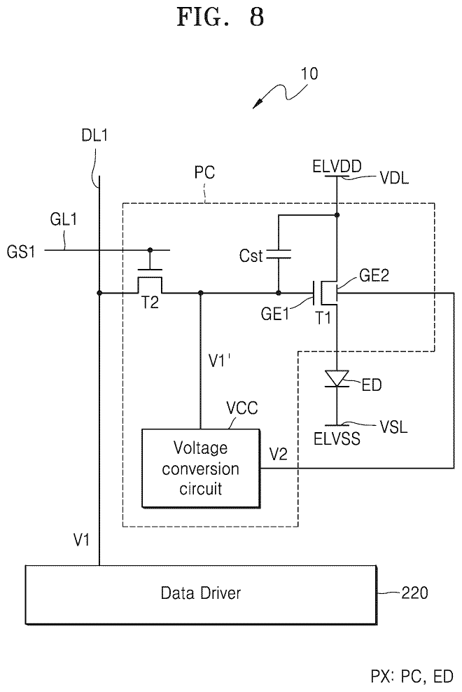

FIG. 8 is a diagram illustrating a display device 10 according to some other embodiments of the present disclosure.

The display device 10 of FIG. 8 may further include a voltage conversion circuit VCC. Some embodiments in which a voltage applied to a first gate electrode GE1 and a voltage applied to a second gate electrode GE2 are controlled by a data driver 220 and the voltage conversion circuit VCC is described with reference to FIG. 8. Hereinafter, mainly the differences between the embodiments illustrated in FIGS. 6 and 7 and the embodiments illustrated in FIG. 8 are described.

In some embodiments, the data driver 220 may be configured to generate a data voltage, and the generated data voltage may be supplied to a first data line DL1.

A first data voltage V1 of the first data line DL1 may be applied to a first gate electrode GE1 of the first transistor T1 through a turned-on second transistor T2. Considering a resistance between a source electrode and a drain electrode of the second transistor T2, the first data voltage V1 of the first data line DL1 may not exactly match a first data voltage V1′ of the first gate electrode GE1. For example, the first data voltage V1′ of the first gate electrode GE1 may be lower than the first data voltage V1 of the first data line DL1.

The voltage converter circuit VCC may be connected between the first gate electrode GE1 and the second gate electrode GE2 of the first transistor T1. The voltage conversion circuit VCC may be configured to receive the first data voltage V1 through the first data line DL1 and the second transistor T2 and convert the first data voltage V1 into a second data voltage V2. The second data voltage V2 from the voltage conversion circuit VCC may be applied to the second gate electrode GE2 of the first transistor T1.

In some embodiments, the voltage conversion circuit VCC may be disposed in a pixel circuit PC.

Because the first data voltage V1 and the second data voltage V2 of FIG. 8 are respectively the same as the first data voltage V1 and the second data voltage V2 of FIG. 6 or 7 described above, a detailed description thereof may not be repeated hereinafter.

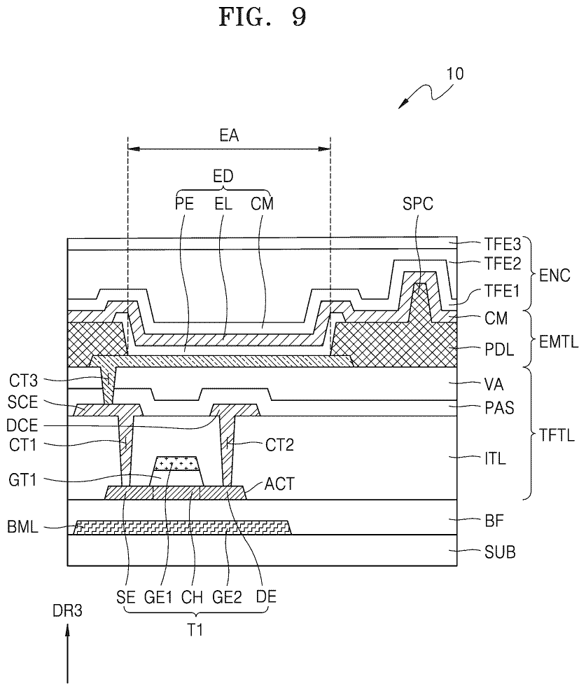

FIG. 9 is a cross-sectional view of a display device 10 including a first transistor, according to some embodiments of the present disclosure.

As illustrated in FIG. 9, the display device 10 according to some embodiments may include a substrate SUB, a light-shielding layer BML, a buffer film BF, a TFT layer TFTL, a light-emitting element layer EMTL, and an encapsulation layer ENC. The light-shielding layer BML, the buffer film BF, the TFT layer TFTL, the light-emitting element layer EMTL, and the encapsulation layer ENC may be sequentially disposed on the substrate SUB in this stated order along the third direction DR3. The TFT layer TFTL may include the first transistor T1, the second transistor T2, and the third transistor T3 described above.

The substrate SUB may be a rigid substrate SUB or a flexible substrate SUB, which is bendable, foldable, or rollable. The substrate SUB may include an insulating material, such as glass, quartz, or polymer resin. Examples of the polymer resin may include polyethersulfone (PES), polyacrylate (PA), polyarylate (PAR), polyetherimide (PEI), polyethylene naphthalate (PEN), polyethylene terephthalate (PET), polyphenylene sulfide (PPS), polyimide (PI), polycarbonate (PC), cellulose triacetate (CAT), cellulose acetate propionate (CAP), or any combination thereof. In some examples, the substrate SUB may include a metal material.

The light-shielding layer BML may be disposed on the substrate SUB. The light-shielding layer BML may be disposed on the substrate SUB to overlap an active layer ACT to be described below. The light-shielding layer BML may include a metal material, such as chromium (Cr) or molybdenum (Mo), black ink, or black dye. In cases where the light-shielding layer BML includes a metal material, the light-shielding layer BML may be supplied with a constant voltage. Accordingly, the light-shielding layer BML may not be electrically floating, and electrical characteristics of the first to third transistors T1, T2, and T3 on the light-shielding layer BML may be stabilized (e.g., may be unaffected by the effects of electrical noise from other electrical components). For example, performance degradation of the oxide-based first to third transistors T1, T2 and T3 may be reduced or minimized. Oxide semiconductors are sensitive to light, and an amount of current or the like may change due to external light. The light-shielding layer BML may include a second gate electrode GE2 of the first transistor T1. In other words, a portion of the light-shielding layer BML may correspond to the second gate electrode GE2 of the first transistor T1.

The buffer film BF may be disposed on the light-shielding layer BML. The buffer film BF may be disposed on the entire surface of the substrate SUB including the light-shielding layer BML. The buffer film BF may be a film that protects the transistors of the TFT layer TFTL and an emission layer EL of the light-emitting element layer EMTL from moisture penetrating through the substrate SUB, which is vulnerable to moisture permeation. The buffer film BF may include a plurality of inorganic films, which are alternately stacked. For example, the buffer film BF may include a multilayer film in which one or more inorganic films selected from a silicon nitride layer, a silicon oxynitride layer, a silicon oxide layer, a titanium oxide layer, and an aluminum oxide layer are alternately stacked.

The active layer ACT may be disposed on the buffer film BF. For example, the active layer ACT may be disposed on the buffer film BF to overlap the second gate electrode GE2 of the light-shielding layer BML. The active layer ACT may be, for example, an oxide semiconductor. For example, the active layer ACT may be a semiconductor including IGZO or IGZTO. The active layer ACT may be, for example, crystalline silicon, polycrystalline silicon, or amorphous silicon.

A gate insulating film GTI may be disposed on the active layer ACT. For example, the gate insulating film GTI may be disposed to overlap a channel region CH of the active layer ACT. The gate insulating film GTI may include at least one of tetraethylorthosilicate (TEOS), silicon nitride (SiNₓ), or silicon oxide (SiO₂). For example, the gate insulating film GTI may have a double-layer film structure in which a silicon nitride film having a thickness of 40 nm and a TEOS film having a thickness of 80 nm are sequentially stacked in this stated order.

The first gate electrode GE1 may be disposed on the gate insulating film GTI. The first gate electrode GE1 may be disposed on the gate insulating film GTI to overlap the channel region CH of the active layer ACT. The first gate electrode GE1 may include aluminum (Al), titanium (Ti), and/or the like. For example, the first gate electrode GE1 may have a double-layer or triple-layer structure in which aluminum (Al) and titanium (Ti) are stacked.

An interlayer insulating film ITL may be disposed on the first gate electrode GE1. The interlayer insulating film ITL may be disposed on the entire surface of the substrate SUB including the first gate electrode GE1. The interlayer insulating film ITL may include an inorganic film, for example, a silicon nitride layer, a silicon oxynitride layer, a silicon oxide layer, a titanium oxide layer, or an aluminum oxide layer. The interlayer insulating film ITL may include a plurality of inorganic films.

A source connection electrode SCE and a drain connection electrode DCE may be disposed on the interlayer insulating film ITL. The source connection electrode SCE may be connected to a source electrode SE of the active layer ACT through a first contact hole CT1 passing through the interlayer insulating film ITL. The drain connection electrode DCE may be connected to a drain electrode DE of the active layer ACT through a second contact hole CT2 passing through the interlayer insulating film ITL. The source connection electrode SCE and the drain connection electrode DCE may include the same or substantially the same material as a material of the first gate electrode GE1 described above.

A protective film PAS may be disposed on the source connection electrode SCE and the drain connection electrode DCE. The protective film PAS may be disposed on the entire surface of the substrate SUB including the interlayer insulating film ITL. The protective film PAS may include the same or substantially the same material as a material of the interlayer insulating film ITL.

A planarization film VA may be disposed on the protective film PAS. The protective film PAS may be disposed on the entire surface of the substrate SUB including the planarization film VA. The planarization film VA may include an organic film, such as acryl resin, epoxy resin, phenolic resin, polyamide resin, or polyimide resin.

The light-emitting element layer EMTL including a pixel electrode PE, a light-emitting element ED, and a pixel defining film PDL may be disposed on the planarization film VA. The pixel electrode PE may be connected to the source connection electrode SCE through a third contact hole CT3 passing through the planarization film VA. The pixel electrode PE may be connected to the source electrode SE of the active layer ACT through the source connection electrode SCE.

The light-emitting element ED may include the pixel electrode PE, the emission layer EL, and a common electrode CM. An emission area EA refers to an area where the pixel electrode PE, the emission layer EL, and the common electrode CM are sequentially stacked and holes from the pixel electrode PE and electrons from the common electrode CM recombine with each other in the emission layer EL to emit light. In this case, the pixel electrode PE may be an anode electrode of the light-emitting element ED, and the common electrode CM may be a cathode electrode of the light-emitting element ED.

In a top emission structure, which emits light toward the common electrode CM with respect to the emission layer EL, the pixel electrode PE may include a single layer including molybdenum (Mo), titanium (Ti), copper (Cu), or aluminum (Al), or may be formed in a stacked structure (Ti/Al/Ti) of aluminum and titanium, a stacked structure (ITO/Al/ITO) of aluminum and indium tin oxide (ITO), an APC alloy, or a stacked structure (ITO/APC/ITO) of an APC alloy and ITO so as to increase reflectivity. The APC alloy is an alloy of silver (Ag), palladium (Pd), and copper (Cu).

The pixel defining film PDL defines the emission areas EA of the pixel. To this end, the pixel defining film PDL may be disposed to expose a portion of the pixel electrode PE on the planarization film VA. The pixel defining film PDL may cover edges of the pixel electrode PE. The pixel defining film PDL may include an organic film, such as acryl resin, epoxy resin, phenolic resin, polyamide resin, or polyimide resin.

A spacer SPC may be disposed on the pixel defining film PDL. The spacer SPC may support a mask in a process of forming the emission layer EL. The spacer SPC may include an organic film, such as acryl resin, epoxy resin, phenolic resin, polyamide resin, or polyimide resin.

The emission layer EL may be formed on the pixel electrode PE. The emission layer EL may be configured to emit light of a certain color by including an organic material. For example, the emission layer EL may include a hole transporting layer, an organic material layer, and an electron transporting layer. The organic material layer may include a host and a dopant. The organic material layer may include a material that emits certain light and may be formed by using a phosphorescent material or a fluorescent material.

The plurality of pixels may include a first pixel configured to emit light of a first color through a first emission area, a second pixel configured to emit light of a second color through a second emission area, and a third pixel configured to emit light of a third color through a third emission area.

An organic material layer of a first emission layer of the first emission area that emits light of the first color may be a phosphorescent material including a host material including carbazole biphenyl (CBP) or mCP (1,3-bis(carbazol-9-yl)) and a dopant including at least one selected from bis(1-phenylisoquinoline)acetylacetonate iridium (PIQIr(acac)), bis(1-phenylquinoline)acetylacetonate iridium (PQIr(acac)), tris(1-phenylquinoline)iridium (PQIr), and octaethylporphyrin platinum (PtOEP). For example, the organic material layer of the first emission layer of the first emission area may be a fluorescent material including PBD: Eu(DBM)3(Phen) or perylene, but the present disclosure is not limited thereto.

An organic material layer of a second emission layer of the second emission area that emits light of the second color may be a phosphorescent material including a host material including CBP or mCP and a dopant material including Ir(ppy)3(fac tris(2-phenylpyridine) iridium). For example, the organic material layer of the second emission layer of the second emission area that emits light of the second color may be a fluorescent material including tris(8-hydroxyquinolino)aluminum (Alq3), but the present disclosure is not limited thereto.

An organic material layer of a third emission layer of the third emission area that emits light of the third color may be a phosphorescent material including a host material including CBP or mCP and a dopant material including (4,6-F2ppy)2Irpic or L2BD111, but the present disclosure is not limited thereto.

The common electrode CM may be disposed on the emission layer EL. For example, the common electrode CM may be disposed on the first, second, and third emission layers. The common electrode CM may be disposed to cover the first, second, and third emission layers. The common electrode CM may be a common layer commonly disposed on the first, second, and third emission layers. A capping layer may be formed on the common electrode CM.

In a top emission structure, the common electrode CM may include a transparent conductive material (TCO), such as ITO or IZO, which is capable of transmitting light, or a semi-transmissive conductive material, such as magnesium (Mg), silver (Ag), or an alloy of magnesium (Mg) and silver (Ag). In cases where the common electrode CM includes a semi-transmissive conductive material, the light output efficiency may be increased by a micro-cavity.

The encapsulation layer ENC may be formed on the light-emitting element layer EMTL. The encapsulation layer ENC may include at least one inorganic film TFE1 and TFE3 so as to prevent or substantially reduce infiltration of oxygen or moisture into the light-emitting element layer EMTL. For example, the encapsulation layer ENC may include at least one organic film so as to protect the light-emitting element layer EMTL from foreign materials, such as dust. For example, the encapsulation layer ENC may include a first encapsulation inorganic film TFE1, an encapsulation organic film TFE2, and a second encapsulation inorganic film TFE3.

The first encapsulation inorganic film TFE1 may be disposed on the common electrode CM, the encapsulation organic film TFE2 may be disposed on the first encapsulation inorganic film TFE1, and the second encapsulation inorganic film TFE3 may be disposed on the encapsulation organic film TFE2. The first encapsulation inorganic film TFE1 and the second encapsulation inorganic film TFE3 may each include a multilayer film in which one or more inorganic films selected from a silicon nitride layer, a silicon oxynitride layer, a silicon oxide layer, a titanium oxide layer, and an aluminum oxide layer are alternately stacked. The encapsulation organic film TFE2 may be an organic film, such as acryl resin, epoxy resin, phenolic resin, polyamide resin, or polyimide resin.

A barrier film may be further disposed between the substrate SUB and the light-shielding layer BML. The barrier film may be a film that protects the transistors T1 to T3 of the TFT layer TFTL and the emission layer EL of the light-emitting element layer EMTL from moisture penetrating through the substrate SUB, which is vulnerable to moisture permeation. The barrier film may include a plurality of inorganic films, which are alternately stacked. For example, the barrier film may include a multilayer film in which one or more inorganic films selected from a silicon nitride layer, a silicon oxynitride layer, a silicon oxide layer, a titanium oxide layer, and an aluminum oxide layer are alternately stacked.

The pixel circuit or the display device according to various embodiments may be applied to various electronic devices. An electronic device according to some embodiments may include the pixel circuit or the display device described above and may further include a module or a device having additional functions other than the pixel circuit or the display device.

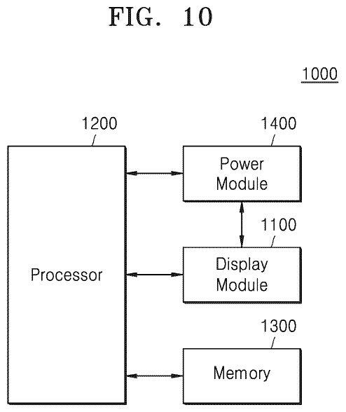

FIG. 10 is a block diagram of an electronic device 1000 according to some embodiments of the present disclosure.

Referring to FIG. 10, the electronic device 1000 according to some embodiments may include a display module 1100, a processor 1200, a memory 1300, and a power module 1400.

The processor 1200 may include at least one of a central processing unit (CPU), an application processor (AP), a graphics processing unit (GPU), a communication processor (CP), an image signal processor (ISP), or a controller.

Data information necessary for the operation of the processor 1200 or the display module 1100 may be stored in the memory 1300. In cases where the processor 1200 executes an application stored in the memory 1300, an image data signal and/or an input control signal may be transmitted to the display module 1100, and the display module 1100 may process the received signal and output image information on a display screen.

The power module 1400 may include a power supply module, such as a power adapter or a battery device, and a power conversion module that converts power supplied by the power supply module and generate power necessary for the operation of the electronic device 1000.

At least one of components of the electronic device 1000 may be included in the display device according to the embodiments described above. Furthermore, some of the individual modules functionally included in a single module may be included in the display device, and others thereof may be provided separately from the display device. For example, the display device may include the display module 1100, and the processor 1200, the memory 1300, and the power module 1400 may be provided in the form of other devices in the electronic device 1000 other than the display device.

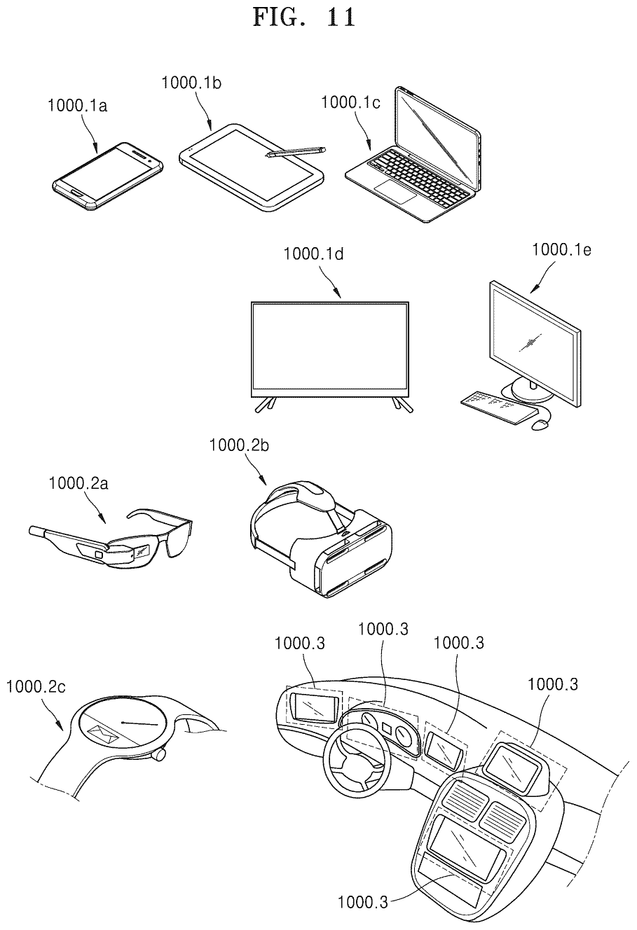

FIG. 11 is a schematic diagram of electronic devices according to some embodiments of the present disclosure.

Referring to FIG. 11, various electronic devices to which the display device according to some embodiments are applied may include image display electronic devices, such as a smartphone 1000.1a, a tablet PC 1000.1b, a laptop 1000.1c, a television (TV) 1000.1d, or a desk monitor 1000.1e, wearable electronic devices including display modules, such as smart glasses 1000.2a, a head mounted display 1000.2b, or a smart watch 1000.2c, and vehicle electronic devices 1000.3 including display modules, such as a dashboard of an automobile, center information display (CID) on center fascia or dashboard, or a room mirror display.

According to various embodiments, detailed gray scale expression may be made and power consumption may be reduced.

However, effects to be achieved by the present disclosure are not limited to those described above, and other effects that are not described herein will be clearly understood from the following description by those of ordinary skill in the art.

The embodiments described above may be implemented independently, or the structure of each of the embodiments may be applied in combination to other embodiments.

The disclosure has been described with reference to the embodiments illustrated in the drawings, however, these are merely examples. It will be understood by those of ordinary skill in the art that various suitable modifications and equivalents may be made thereto. Accordingly, the true technical protection scope of the present disclosure should be defined by the appended claims and equivalents thereto.

Specific implementation described in the embodiments are only example embodiments, which do not limit the scope of the embodiments in any way. In addition, when there is no specific mention such as “essential” or “important,” it may not be a necessary component for the application of the present disclosure.

The use of the term “the” and similar demonstratives in the specification of the embodiments (in particular, the claims) is to be construed to cover both the singular and the plural. In addition, when a range is described in the embodiments, it includes the invention to which individual values within the range are applied (unless otherwise indicated herein). This is the same as stating each individual value constituting the above range in the detailed description. Finally, operations constituting methods according to embodiments may be performed in any suitable order unless otherwise indicated herein or otherwise clearly contradicted by context. The embodiments are not necessarily limited by the order of the description of the operations. The use of any and all examples or exemplary terms provided in the embodiments is simply intended to describe the embodiments in detail, and the scope of the embodiments is not limited by the examples or exemplary terms unless otherwise claimed. In addition, it will be understood by those of ordinary skill in the art that various modifications, combinations and changes may be made according to design conditions and factors within the scope of the appended claims or equivalents thereof.

What is claimed is:

1. A display device comprising:
a light-emitting element; and
a first transistor connected between a driving voltage line and the light-emitting element, and comprising a first gate electrode and a second gate electrode positioned to face each other, the first transistor being configured to control a driving current based on a voltage applied to the first gate electrode and a voltage applied to the second gate electrode,
wherein a voltage relationship between the voltage applied to the first gate electrode and the voltage applied to the second gate electrode is controlled based on a display mode.

2. The display device of claim 1, further comprising:
a first data line connected to the first gate electrode of the first transistor;
a second data line connected to the second gate electrode of the first transistor; and
a data driver connected to the first data line and the second data line.

3. The display device of claim 2, wherein the data driver is configured to apply a first data voltage to the first gate electrode and a second data voltage to the second gate electrode based on the display mode.

4. The display device of claim 2, further comprising:
a second transistor connected between the first data line and the first gate electrode and configured to turn on in response to a first gate signal; and
a third transistor connected between the second data line and the second gate electrode and configured to turn on in response to a second gate signal.

5. The display device of claim 1, further comprising:
a first data line connected to the first gate electrode of the first transistor;
a second data line connected to the second gate electrode of the first transistor;
a data driver connected to the first data line; and
a voltage conversion circuit connected between the first data line and the second data line.

6. The display device of claim 5, wherein the data driver is configured to apply a first data voltage to the first data line, and
wherein the voltage conversion circuit is configured to generate a second data voltage according to the first data voltage of the first data line and to apply the second data voltage to the second data line.

7. The display device of claim 5, further comprising:
a second transistor connected between the first data line and the first gate electrode and configured to turn on in response to a first gate signal; and
a third transistor connected between the second data line and the second gate electrode and configured to turn on in response to a second gate signal.

8. The display device of claim 1, further comprising:
a data line connected to the first gate electrode of the first transistor;
a data driver connected to the data line; and
a voltage conversion circuit connected between the first gate electrode of the first transistor and the second gate electrode of the first transistor.

9. The display device of claim 8, wherein the data driver is configured to apply a first data voltage to the data line, and
wherein the voltage conversion circuit is configured to generate a second data voltage based on the first data voltage applied to the first gate electrode through the data line, and to apply the second data voltage to a second data line.

10. The display device of claim 8, further comprising:
a second transistor connected between the data line and the first gate electrode and configured to turn on in response to a first gate signal.

11. The display device of claim 1, wherein the display mode comprises a first mode for detailed gray scale expression in a low gray scale region and a second mode for output efficiency in a high gray scale region.

12. The display device of claim 11, wherein, in the first mode, in response to the voltage applied to the first gate electrode increasing, the voltage applied to the second gate electrode decreases.

13. The display device of claim 11, wherein, in the second mode, response to the voltage applied to the first gate electrode increasing, the voltage applied to the second gate electrode increases.

14. An electronic device comprising:
a memory;
a processor configured to execute an application stored in the memory; and
a display module configured to process a signal transmitted from the processor and to output image information, the display module comprising:
a light-emitting element; and
a first transistor connected between a driving voltage line and the light-emitting element, and comprising a first gate electrode and a second gate electrode positioned to face each other, the first transistor being configured to control a driving current based on a voltage applied to the first gate electrode and a voltage applied to the second gate electrode,
wherein a voltage relationship between the voltage applied to the first gate electrode and the voltage applied to the second gate electrode is controlled based on a display mode.

15. The electronic device of claim 14, further comprising:
a first data line connected to the first gate electrode of the first transistor;
a second data line connected to the second gate electrode of the first transistor; and
a data driver connected to the first data line and the second data line.

16. The electronic device of claim 15, wherein the data driver is configured to apply a first data voltage to the first gate electrode and a second data voltage to the second gate electrode based on the display mode.

17. The electronic device of claim 14, further comprising:
a first data line connected to the first gate electrode of the first transistor;
a second data line connected to the second gate electrode of the first transistor;
a data driver connected to the first data line; and
a voltage conversion circuit connected between the first data line and the second data line.

18. The electronic device of claim 17, wherein the data driver is configured to apply a first data voltage to the first data line, and
wherein the voltage conversion circuit is configured to generate a second data voltage according to the first data voltage of the first data line and to apply the second data voltage to the second data line.

19. The electronic device of claim 14, further comprising:
a data line connected to the first gate electrode of the first transistor;
a data driver connected to the data line; and
a voltage conversion circuit connected between the first gate electrode of the first transistor and the second gate electrode of the first transistor.

20. The electronic device of claim 19, wherein the data driver is configured to apply a first data voltage to the data line, and
wherein the voltage conversion circuit is configured to generate a second data voltage, based on the first data voltage applied to the first gate electrode through the data line, and to apply the second data voltage to a second data line.
